(19) United States
(12) Patent Application Publication
(10) Pub. No.: US 2008/0236684 A1
(43) Pub. Date: Oct. 2, 2008

(54) Piping System of the Air Supply to a Several Calm Hair Dryer for the Beauty Parlor Shop

(76) Inventor: Gook Hyun Shim, Daejeon (KR)

Correspondence Address: PARK LAW FIRM, 3255 WILSHIRE BLVD, SUITE 1110, LOS ANGELES, CA, 90010, US

(21) Appl. No.: 12/065,957

(22) PCT Filed: Apr. 20, 2007
(86) PCT No.: PCT/KR2007/001930

§ 371 Date: Mar. 6, 2008

(30) Foreign Application Priority Data
Apr. 22, 2006 (KR) 1020060036468

(51) Int. Cl. E03B 5/02; A45D 20/12; F16K 31/02

(52) U.S. Cl. 137/565.23; 34/96; 251/129.15

(57) ABSTRACT

The present invention is related to a silent hair dryer for supplying a warm current of air, and to a pipe system for using in beauty shop. The pipe system supplies an air of constant pressure and fixed quantity.

the present invention is characterized in that the pipe system is installed in the inside of a beauty shop, and the pipe system has a compressor, an air flowing pipe, a discharging wall socket, a hose and a hair dryer. The compressor inhales an air from the outside to generate a compressed air and discharges the compressed air to the outside. The air flowing pipe is connected to an outlet of the compressor, and the compressed air is supplied from the compressor flowing through the air flowing pipe. The air flowing pipe is laid in a ceiling and an edge of wall surface of the beauty shop to be led to the lower part of a chair. The discharge wall socket shuts and discharges the compressed air flowed along the air flowing pipe, and formed by numbers of air discharging holes and provided to an end of the air flowing pipe. The hose guides the compressed air supplied from the air flowing pipe, and is inserted into the discharging wall socket. The hair dryer is connected to an end of the hose to heat the compressed air and to discharge the heated, compressed air to the outside.

### TECHNICAL FIELD

The present invention is related to a silent hair dryer for supplying a warm current of air, and to a pipe system for using in beauty shop. The pipe system supplies an air of constant pressure and fixed quantity.

### BACKGROUND ART

Generally, a hair dryer used in a beauty shop has a heating coil capable of varying a temperature thereof, and an air blast motor capable of regulating a speed of blasted air therein.

When the hair dryer is applied with an electric power, the hair dryer is actuated to inhale air from the outside. The inhaled air is blasted into the inside of the hair dryer, and the blasted air is passing through the heating coil. Then, the temperature of the air is varied, and the air is finally supplied to the outside to dry a hair.

The number of hair dryer used in the beauty shop depends on a scale of the beauty shop, and the hair dryers are supplied with a separate electric power in order to operate.

In case of using numbers of hair dryers, the noise of the hair dryer is unimaginably increased. Therefore, the customer who is served by the beauty shop feels severely unpleasant feelings.

Meanwhile, there is a problem that electric wires which are separately used in numbers of hair dryers or curling irons get tangled with each other, and a separate wall socket is used for each of the hair dryers and curling irons in order to solve the tangle of the wires. Therefore, the inside of the beauty shop is disordered by the wires and the wall sockets to lead a deterioration of service.

### DISCLOSURE OF INVENTION

### Technical Solution

Therefore, the present invention is devised to overcome the problem. An object of the present invention is to provide a variable air blast hair dryer which blasts an air constantly inhaled and heated with a constant pressure and fixed quantity to dry a hair, and to provide a pipe system for an air to the dryer. In the variable air blast hair dryer, a motor for blasting an air, which is a main factor generating a noise is omitted.

In a preferred embodiment, a hair dryer according to the present invention overcomes the above-cited problem, and is provided with an actuating switch for regulating the volume and pressure of an air passing through the inside of the dryer, and a controller connected to the actuating switch to regulate the volume of a blast air.

A pipe system used in a beauty shop for blasting an air to a hair dryer according to the present invention is provided with a compressor for generating a compressed air, and a compressed air flowing pipe which is connected to an outlet of the compressor and piped into the inside of the beauty shop. The flowing pipe is extended around a chair to connect with the hair dryer.

### Advantageous Effects

By the pipe system for supplying an air to numbers of hair dryers according to the present invention, provided are a variable air blast hair dryer which blasts an air constantly inhaled and heated with a constant pressure and fixed quantity to dry a hair without a motor for blasting an air which is a main factor generating a noise, and a pipe system for the air to the dryer to achieve that a noise generated in a beauty shop is minimized, a working environment is improved and a customer reliability for a service quality is increased.

### BRIEF DESCRIPTION OF THE DRAWINGS

The above objects and other advantages of the present invention will become more apparent by describing in detail the preferred embodiments of the present invention with reference to the attached drawings in which:

FIGS. 1 and 2 show schematically a state in which a pipe system for supplying an air to numbers of hair dryers according to the present invention is installed;

FIG. 3 is a perspective diagram which shows a hair dryer used in a pipe system according to the present invention;

FIG. 4 is a cross sectional diagram which shows the inside of a hair dryer according to the present invention; and

FIG. 5 is an exploded diagram which shows a damper and an actuator in order to show an operational state of a hair dryer according to the present invention.

### BRIEF DESCRIPTION OF REFERENCE NUMBERS

10: compressor

12: outlet

20: air flowing pipe

30: discharging wall socket

32: electronic valve

40: hose

50: hair dryer

52: air container

54: air blasting passage

60: operating switch

70: heating coil

### BEST MODE FOR CARRYING OUT THE INVENTION

In a pipe system using a compressed air normally supplied, the present invention is characterized in that the pipe system is installed in the inside of a beauty shop, and the pipe system has a compressor, an air flowing pipe, a discharging wall socket, a hose and a hair dryer. The compressor inhales an air from the outside to generate a compressed air and discharges the compressed air to the outside. The air flowing pipe is connected to an outlet of the compressor, and the compressed air is supplied from the compressor flowing through the air flowing pipe. The air flowing pipe is laid in a ceiling and an edge of wall surface of the beauty shop to be led to the lower part of a chair. The discharge wall socket shuts and discharges the compressed air flowed along the air flowing pipe, and formed by numbers of air discharging holes and provided to an end of the air flowing pipe. The hose guides the compressed air supplied from the air flowing pipe, and is inserted into the discharging wall socket. The hair dryer is connected to an end of the hose to heat the compressed air and to discharge the heated, compressed air to the outside.

Further, the hair dryer has an air container which is communicated with the hose and abruptly expanded. The air container is vertically bent and is further extended to form an air blasting passage communicated with the outside. A damper is installed between the air container and the air blasting passage to seal the compressed air or to flow the compressed air through the air blasting passage. The damper is connected to a rotating axis to seal the inside of the hair dryer. The rotating axis is projected to the outside to connect with an actuator which is operated by multi-steps. The actuator is rotated by multi-steps under the controlling of a solenoid valve. The solenoid valve receives an electrical signal from a switch installed on the outside of the dryer. The solenoid valve receiving the electrical signal receives a compressed air from a branch hose branched from the hose to operate the actuator.

Preferably, the solenoid valve is integrally installed in the inside of the actuator.

Hereinafter, the preferred embodiment of a pipe system for using in a beauty shop and supplying air to numbers of silent hair dryers according to the present invention will be described in detail with reference to the accompanying drawings. Throughout the drawings, same reference numbers are used for functionally same parts or similar parts.

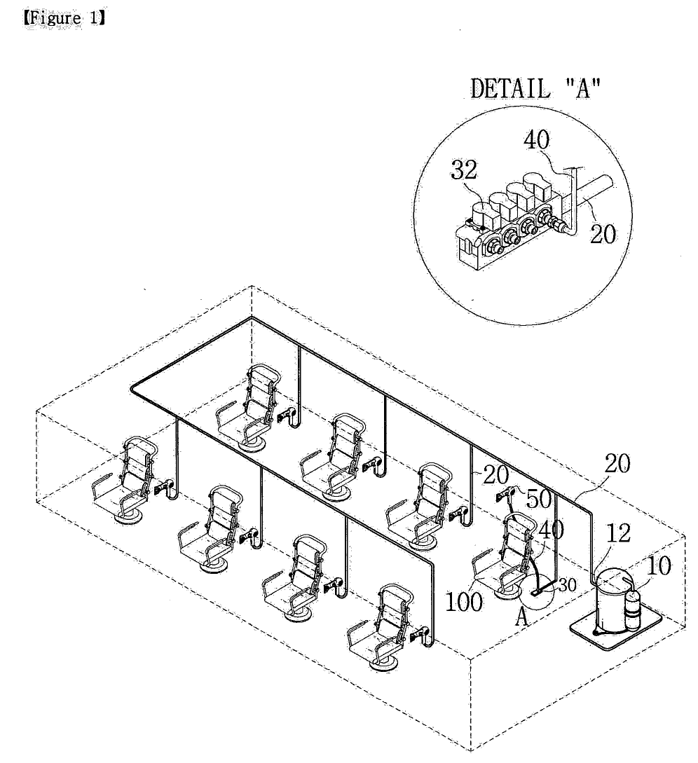

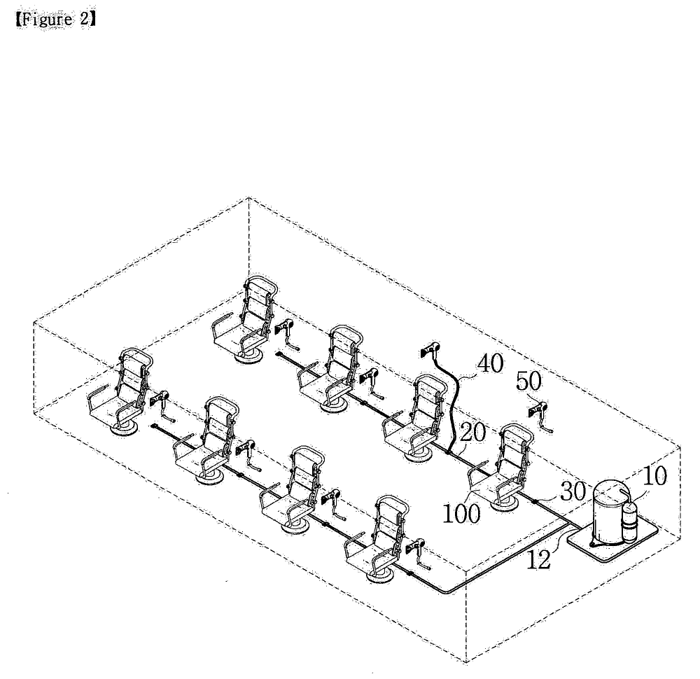

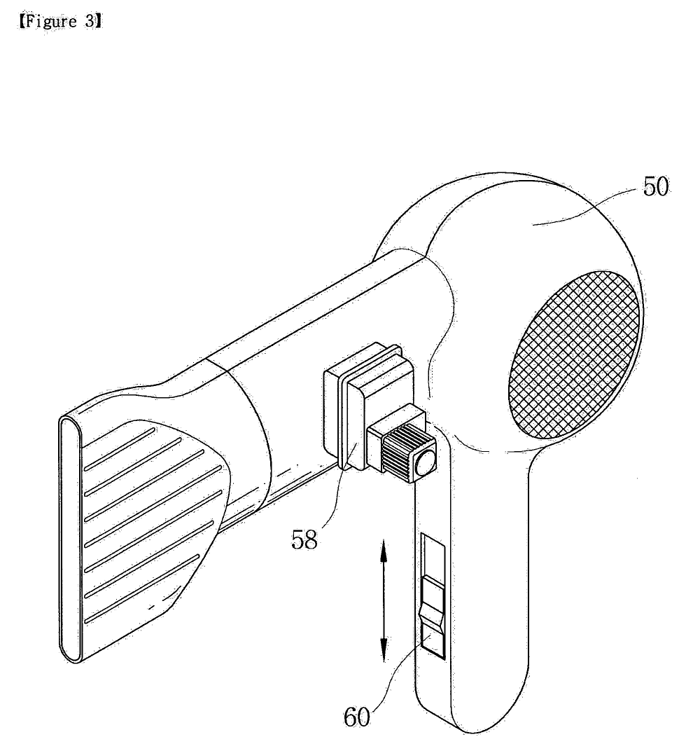

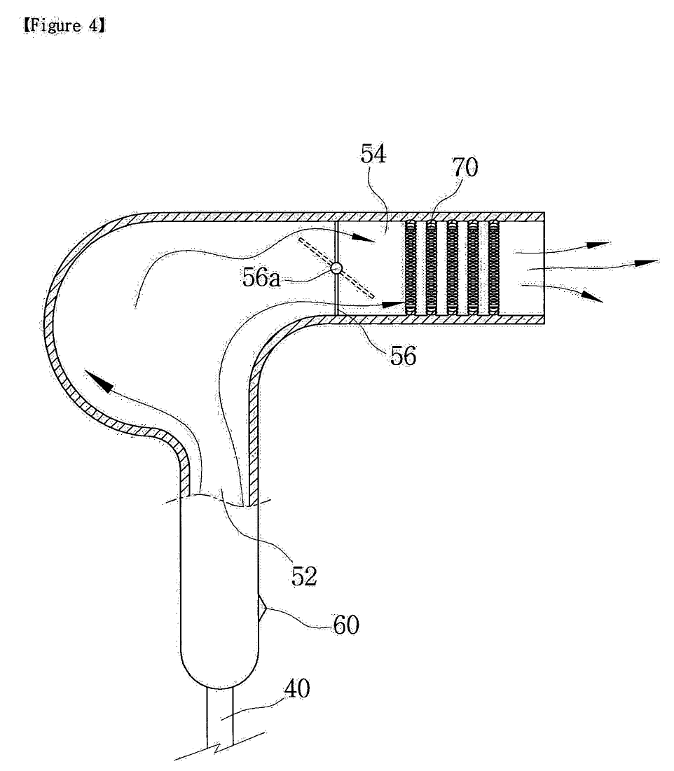

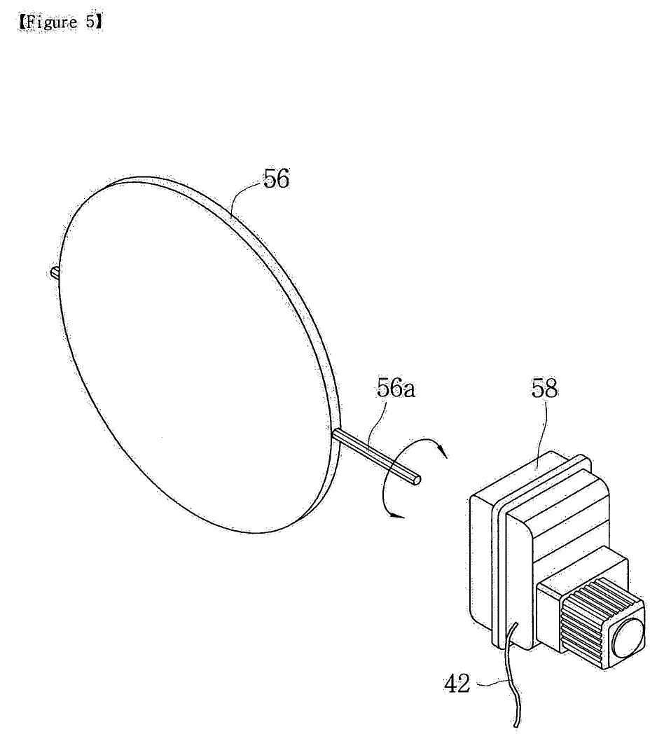

FIGS. 1 and 2 show schematically a state in which a pipe system for supplying an air to numbers of hair dryers according to the present invention is installed, FIG. 3 is a perspective diagram which shows a hair dryer used in a pipe system according to the present invention, FIG. 4 is a cross sectional diagram which shows the inside of a hair dryer according to the present invention, and FIG. 5 is an exploded diagram which shows a damper and an actuator in order to show an operational state of a hair dryer according to the present invention.

As shown in FIGS. 1 and 3, a pipe system of a beauty shop for supplying air to numbers of hair dryers according to the present invention is a pipe system using a compressed air and used in a beauty shop.

The pipe system is installed in the inside of the beauty shop. The pipe system has a compressor(10) which sucks an air for the outside of the beauty shop and discharges the air into the inside of the beauty shop.

The compressor(10) used in the present invention is a positive displacement type, a centrifugal type, a screw type or a reciprocating type. In the reciprocating type, a crank case has the same pressure as that of a sucking part, and a distance piece and a cross head are omitted. In the screw type, a timing gear is omitted. In the centrifugal type, a contact mechanical seal type is adapted, at least five horse powers are needed and an outlet(12) which discharges compressed air is installed one side.

An air flowing pipe(20) in which an air flows is connected to the outlet(12). After the air flowing pipe(20) is connected to the outlet(12), the air flowing pipe is further extended. Preferably, the air flowing pipe is laid in the ceiling, an edge of a wall surface or a floor of the beauty shop in order to flow the air supplied from the compressor(10).

Preferably, a dryer (not shown), filter and a pressure gauge are installed between the outlet(12) and the air flowing pipe(20) in order to supply a compressed air generated in the compressor(10) with a constant pressure and a fixed quantity.

The reason why the air flowing pipe(20) is laid in the edge of the wall surface or the floor of the beauty shop is for the interior. As the beauty shop is always cleaned and arranged, the air flowing pipe must be laid in the edge of the wall surface or the floor of the beauty shop.

In the present invention, the air flowing pipe(20) is made of plastics, ironworks or nonferrous metals, and extended to various directions and positions. More preferably, the air flowing pipe is projected to the lower part of a chair(100) in case of the air flowing pipe laid in the floor.

Preferably, an electronic valve(32) is installed on one end of the air flowing pipe(20) in order to regulate and control the air flowing in the air flowing pipe(20). The electronic valve is connected to a switch in order to actuate an electronic coil in the electronic valve.

Numbers of the electronic valves(32) are piped to form one discharge wall socket(30). The wall socket(30) is preferably installed in the floor of the beauty shop.

A hose(40) is connected the other side of the electronic valves(32) which form the discharge wall socket(30) to induce and guide the compressed air flowed through the air flowing pipe(20).

The hose(40) has various lengths. The length of the hose is preferably within the working area of a hair stylist. In case that the hose is much longer, the hose deteriorates the working environment of the beauty shop and the hair stylist's work. Therefore, the length of the hose is most preferably less than 4 meters.

An hair dryer(50) is attached the end of the hose(40) to heat the compressed air and to blast the heated air to the outside of the dryer.

As shown in FIGS. 4 and 5, the shape of the hair dryer(50) is similar to a general hair dryer. As shown in FIG. 4, the inside of the hair dryer communicates with the hose(40), and has an air container(52) which is rapidly expended. The air container(52) containing the compressed air is vertically bent and further extended to be integral with an air blasting passage(54).

The air container(52) has a specific space in order to supply the compressed air to the air blasting passage(54), and the inside of the air container is tightly sealed against the outside of the dryer.

The air blasting passage(54) discharges the compressed air which is supplied through the air container to dry a hair. The blasting passage has a specific length and a passage in proportion to the amount of blasted air.

A damper(56) is installed between the air container(52) and the air blasting passage(54) to be closed for sealing the compressed air or to be opened for flowing the compressed air through the air blasting passage.

The damper(56) is actuated by a specific control command. A rotating axis(56a) is present on the central axis of the damper, and the damper is rotated up and down, or right and left centering around the rotating axis(56a) to shut the compressed air or to flow the compressed air through the air blasting passage.

An actuator(58) is installed on the end of the axis of the rotating axis(56), preferably on the outside of the hair dryer. The actuator is connected the end of the axis of the rotating axis(56).

The actuator(58) is actuated by an electric signal or a power supplied from the compressor(10), and operated by 4 steps (ready, low speed, medium speed, and high speed). The actuator(58) which is actuated by electricity or pneumatic power is an actuator or solenoid valve which can be obtained from Keihin Co., Ilyoung FA, CKD Co., or Danhae Co.

Preferably, the actuator(58) is defined as a solenoid valve which is installed on an electronic expansion valve or a motor-operated valve, and is operated by multi-steps under the controlling of electric or pneumatic power.

An operating switch(60) is installed on a side of the hair dryer to actuate the hair dryer, and is a variable resistance switch which is electrically connected to the electronic valve(32) and the actuator(58).

The operating switch(60) controls at least four operational commands (preferably, the commands are for controlling the amount of a blasted air via multi-steps, and for controlling a heating temperature of the compressed air).

The damper(56) is operated by the operational commands to regulate the amount of closing/opening of the damper.

As shown in drawings, the damper(56) has various rotating angles. The amount of a blasted air is determined by the state of the damper which is on the rotating angles.

In case of the actuator(58) being operated by pneumatic power, the actuator is connected with or integral with a solenoid valve. A part of a compressed air is passed through a branch hose(42) which is branched off from the hose(42), and inputted in an input port of the solenoid valve to operate the actuator(58). A operational signal can be received as the operating switch(60) is electrically connected with the solenoid valve.

The compressed air passed through the actuator(58) is heated to perform a hair drying function. A heating coil(70) for heating a compressed air is installed in the inside of the air blasting passage(54) along the length direction of the passage.

The heating coil(70) is a heating element used in a normal hair dryer. When electric power applied to the heating coil, the heating coil is instantly heated. The compressed air is passed through the heating coil(70) via the control of the operating switch(60) to be instantly heated and blasted to the outside.

Next, the operational step of the pipe system for supplying air to numbers of hair dryers, and the effect of the pipe system will be described in detail.

When the compressor(10) is operated, a compressed air with high pressure is generated. The compressed air generated is moved along the air flowing pipe(20), and the compressed air moved is further moved to the discharge wall socket(30) which is positioned on the lower part of the chair(100).

The compressed air moved is temporarily shut by the electronic valve(32), and the compressed air shut is sealed between the compressor(10) and the air flowing pipe(20) under a constant pressure state. At this time, the operation of the compressor(10) is stopped by the pressure.

The operating switch(60) is turned on in order to dry a hair, the electronic valve(32) is opened by a signal. At this time, the compressor(10) perceives a state that the pressure is lower, and is restarted to move a compressed air to the air flowing pipe(20).

The compressed air is moved along the hose(40) to be contained in the air container(52) of the hair dryer(50). The compressed air contained in the container is sealed again by the damper(56) in the inside of the hair dryer(50).

On the other hand, when the operating switch(60) is turned on, the heating coil(70) is heated at the same time. The heated heating coil(70) heats a compressed air which will be passed through to prepare a hair drying operation.

When an operator turns on the operating switch, a signal from the operating switch actuates the actuator(58). As described above, the actuator(58) is operated by multi-steps via the controlling of the operating switch(60) to move the damper(56) up and down, or right and left.

When the damper(56) is operated, a compressed air is guided to the air blasting passage(54). The compressed air guided to the passage is passed through the heating coil(70) which is pre-heated, and the heated, compressed air is blasted to the outside.

The operating switch(60) can regulate the amount of a blasted air due to the operation of the actuator(58) and damper(56) which is coupled with the operating switch. When an operator stops work temporarily, the compressor(10) senses the pressure of the air flowing pipe(20) and repeats working and stop to generate a compressed air with proper pressure.

That is to say, as will be apparent from the above description, the present invention can supply a compressed air to numbers of hair dryers to dry a hair without a noise in a beauty shop.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

In the present invention, it is a matter of course that various modifications can be achieved. For example, a step motor(80) other than the actuator(58) and the solenoid valve can be adopted to operate the damper(56) with multi-steps. Therefore such modifications are within the scope of the present invention.

1. A pipe system for supplying air to numbers of hair dryers in a beauty shop comprising:
the pipe system is installed in the inside of the beauty shop; and
the pipe system comprising:
a compressor for inhaling an air from the outside and discharging a compressed air;
an air flowing pipe connected to an outlet of the compressor, the compressed air supplied from said compressor flowing through said air flowing pipe, and said air flowing pipe being laid in a ceiling and an edge of wall surface of the beauty shop to be led to the lower part of a chair;
a discharge wall socket for shutting and discharging the compressed air flowed along the air flowing pipe, said discharge wall socket being formed by numbers of air discharging holes and provided to an end of the air flowing pipe;
a hose for guiding the compressed air supplied from the air flowing pipe, said hose being inserted into the discharging wall socket; and
a hair dryer having a damper and an actuator, said damper being installed in the inside of the dryer and connected to an end of the hose to heat the compressed air and to control blasting of the heated discharge to the outside, and said actuator being the outside of the dryer to operate said damper.

2. The pipe system as claimed in claim 1, wherein a solenoid valve is integrally installed in the inside of said actuator.

3. The pipe system as claimed in claim 1, wherein the damper is actuated by a stepping motor.
